(19) United States
(12) Patent Application Publication
(10) Pub. No.: US 2017/0075374 A1
(43) Pub. Date: Mar. 16, 2017

(54) NUMERICAL CONTROL SYSTEM WHICH DISPLAYS VOLTAGE VALUE OF BACKUP BATTERY

(71) Applicant: FANUC CORPORATION, Yamanashi (JP)

(72) Inventors: Youhei Kondou, Yamanashi (JP); Hirofumi Kikuchi, Yamanashi (JP)

(73) Assignee: FANUC CORPORATION, Yamanashi (JP)

(21) Appl. No.: 15/260,530

(22) Filed: Sep. 9, 2016

(30) Foreign Application Priority Data
Sep. 10, 2015 (JP) 2015-178810

(51) Int. Cl. G05F 1/66; G05B 19/406; H02J 9/06

(52) U.S. Cl. CPC G05F 1/66; H02J 9/061; G05B 19/406; G05B 2219/24138

(57) ABSTRACT

A numerical control system includes a numerical controller, an absolute encoder which detects a rotational displacement of a motor controlled by the numerical controller, batteries each of which supplies backup power to at least one of the numerical controller and the absolute encoder, A/D conversion circuits which analog/digital-convert voltages output from the batteries and output digital signals, the A/D conversion circuits being located in one device selected from the numerical controller and the absolute encoder and supplied with a backup voltage by the battery, and a display which displays the voltage values of the batteries on the basis of the above-mentioned digital signals and is located in the numerical controller.

### BACKGROUND OF THE INVENTION

1. Field of the Invention

The present invention relates to a numerical control system equipped with a battery for backup operation.

2. Description of the Related Art

In machine tools, CNC (Computerized Numerical Control; to be simply referred to as “numerical control” hereinafter) is generally used for movement control of tools and the like.

FIG. 8 is a block diagram illustrating the general configuration of a numerical control system. Referring to FIG. 8, thin solid lines connecting the blocks together indicate signal lines, and thick solid lines indicate power lines. In a numerical control system 1000, a numerical controller 111 is connected to a servo-amplifier 3 for supplying drive power to a servomotor 2 equipped with a tool (not illustrated). The servomotor 2 is connected to an absolute encoder 112, which detects a rotational displacement of the servomotor 2. The rotational displacement of the servomotor 2 detected by the absolute encoder 112 is fed back to the numerical controller 111 and used for numerical control by the numerical controller 111. The numerical controller 111 controls the power output from the servo-amplifier 3 to perform desired operations of the tool, on the basis of the rotational displacement of the servomotor 2.

The numerical controller 111 is generally equipped with a display 115 for displaying various types of information, and a battery 113-1 serving as a backup power supply at the time of power shutoff. In the absolute encoder 112, a battery 113-2 serving as a backup power supply at the time of power shutoff is similarly connected to the servo-amplifier 3 and supplies power to a backup circuit 121 in the absolute encoder 112.

Conventionally, in a numerical control system, when the battery voltage drops to a predetermined value or less in association with deterioration of a battery for backup operation which supplies power to an absolute encoder or a numerical controller, a battery voltage drop alarm is displayed on a display of a numerical control unit to notify the operator of the period to replace the battery.

For example, as disclosed in Japanese Laid-open Patent Publication No. 2003-256084, one battery monitoring system is known to predict the period during which a battery comes to the end of its life, from the overall operation time of the battery, the number of battery charges, and the actual operation time of the battery after the completion of battery charge.

As another example, as disclosed in Japanese Laid-open Patent Publication No. H11-089101, one battery replacement period detector is known to calculate the period to replace a battery on the basis of the usage time of the battery or a preset life and the usage time of the battery.

As still another example, as disclosed in Japanese Laid-open Patent Publication No. 2003-22486, one battery-powered CO alarm is known to calculate the gradient of the drop in cell voltage of a battery to predict the day on which the cell voltage will drop, on the basis of the calculated gradient.

The discharge characteristics generally vary depending on the type of battery and, for example, a battery whose voltage at the end of discharge abruptly drops exists. FIGS. 9A and 9B are graphs illustrating exemplary discharge characteristics of batteries. One type of battery drops in voltage at a nearly constant rate, as illustrated as FIG. 9A, while another type of battery abruptly drops in voltage at the end of discharge, as illustrated as FIG. 9B.

For example, in a numerical control system, a battery for backup operation which supplies power to an absolute encoder or a numerical controller, as illustrated as FIG. 9A, is compared with that as illustrated as FIG. 9B. Assuming that a battery voltage drop alarm occurs when the battery voltage becomes less than V₁, and backup data for the numerical controller is lost when the battery voltage becomes less than V₂, even when battery voltage drop alarms occur for the batteries illustrated as FIGS. 9A and 9B at the same time instant T₁, a time instant T₂ at which the backup data will be lost is earlier in the battery whose voltage abruptly drops at the end of discharge as illustrated in FIG. 9B than in the battery illustrated in FIG. 9A. Therefore, when, like the battery illustrated as FIG. 9B, the battery used abruptly drops in voltage at the end of discharge, the time “T₃-T₂” since the occurrence of a battery voltage drop alarm (time instant T₂) until battery replacement (time instant T₃) may be insufficient to enable the operator to replace the battery. Once the backup data is lost in the numerical control system, it takes much time and trouble to perform various recovery operations, such as origin return operation and resetting of parameters and programs for the numerical controller.

According to the technique disclosed in, e.g., Japanese Laid-open Patent Publication No. 2003-22486, since the day on which the cell voltage will drop is predicted on the basis of the gradient of the drop in cell voltage of the battery, the operator can know the time instant at which, e.g., backup data for the numerical controller will be lost, as described above, regardless of the type of battery. However, according to the technique disclosed in Japanese Laid-open Patent Publication No. 2003-22486, it is needed to separately provide an alarming unit which sends the day on which the cell voltage will drop, thus entailing an additional cost.

### SUMMARY OF INVENTION

In consideration of the above-described problems, it is an object of the present invention to provide a low-cost numerical control system which can easily predict an appropriate period to replace a backup battery.

In order to achieve the above-described object, a numerical control system includes a numerical controller, an absolute encoder which detects a rotational displacement of a motor controlled by the numerical controller, a battery which supplies backup power to at least one device selected from the numerical controller and the absolute encoder, an A/D conversion circuit which analog/digital-converts a voltage output from the battery and outputs a digital signal, the A/D conversion circuit being located in the one device selected from the numerical controller and the absolute encoder which one device is supplied with backup power by the battery, and a display which displays a voltage value of the battery on the basis of the above-mentioned digital signal and is located in the numerical controller.

The numerical control system may further include a battery voltage monitoring unit which monitors a voltage drop tendency of the battery on the basis of the above-mentioned digital signal, and a replacement period prediction unit which predicts a period to replace the battery on the basis of the voltage drop tendency, wherein the display may display the period to replace the battery predicted by the replacement period prediction unit.

The battery voltage monitoring unit and the replacement period prediction unit are located in the one device selected from the numerical controller and the absolute encoder and supplied with a backup voltage by the battery.

The numerical control system may further include a battery voltage monitoring unit which monitors a voltage drop tendency of the battery on the basis of the above-mentioned digital signal, and a battery identification unit which identifies a type of the battery on the basis of the voltage drop tendency, wherein the display may display the type of the battery identified by the battery identification unit.

The battery identification unit may identify a type of the battery using, as the voltage drop tendency, an amount of voltage variation of the battery during a period in which a power of the battery consumed by one of the numerical controller and the absolute encoder is higher than a predetermined value.

The battery voltage monitoring unit and the battery identification unit are located in the one device selected from the numerical controller and the absolute encoder which one device is supplied with backup power by the battery.

### BRIEF DESCRIPTION OF THE DRAWINGS

The present invention will be more clearly understood by referring to the following accompanying drawings:

FIG. 1 is a block diagram illustrating the configuration of a numerical control system according to a first embodiment;

FIG. 2 is a block diagram illustrating the configuration of a numerical control system according to a second embodiment;

FIGS. 3A and 3B are graphs for explaining battery replacement period prediction in the second embodiment;

FIG. 4 is a block diagram illustrating the configuration of a numerical control system according to third and fourth embodiments;

FIGS. 5A and 5B are graphs for explaining battery type identification in the third embodiment;

FIGS. 6A and 6B are graphs for explaining battery type identification in the fourth embodiment;

FIG. 7 is a block diagram illustrating the configuration of a numerical control system according to a fifth embodiment;

FIG. 8 is a block diagram illustrating the general configuration of a numerical control system; and

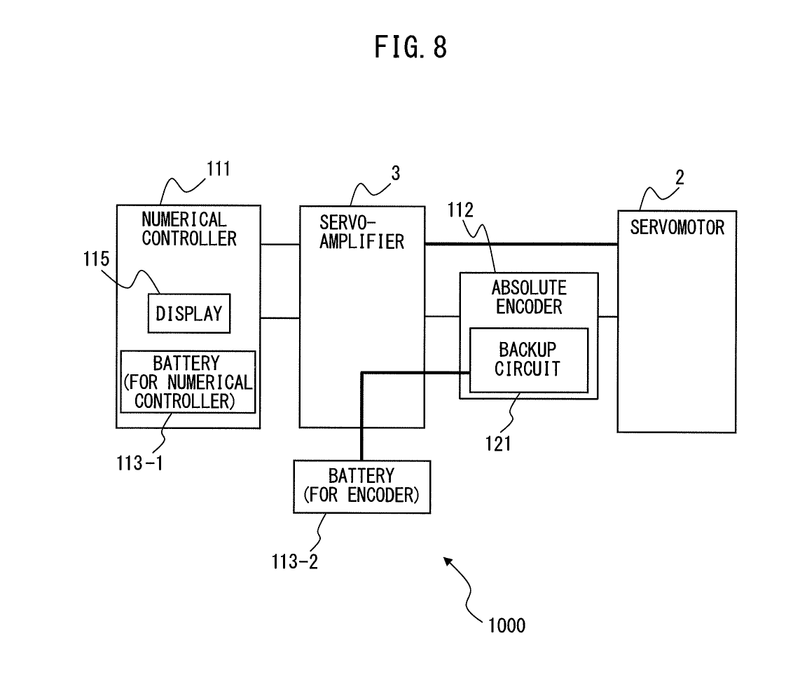

FIGS. 9A and 9B are graphs illustrating exemplary discharge characteristics of batteries.

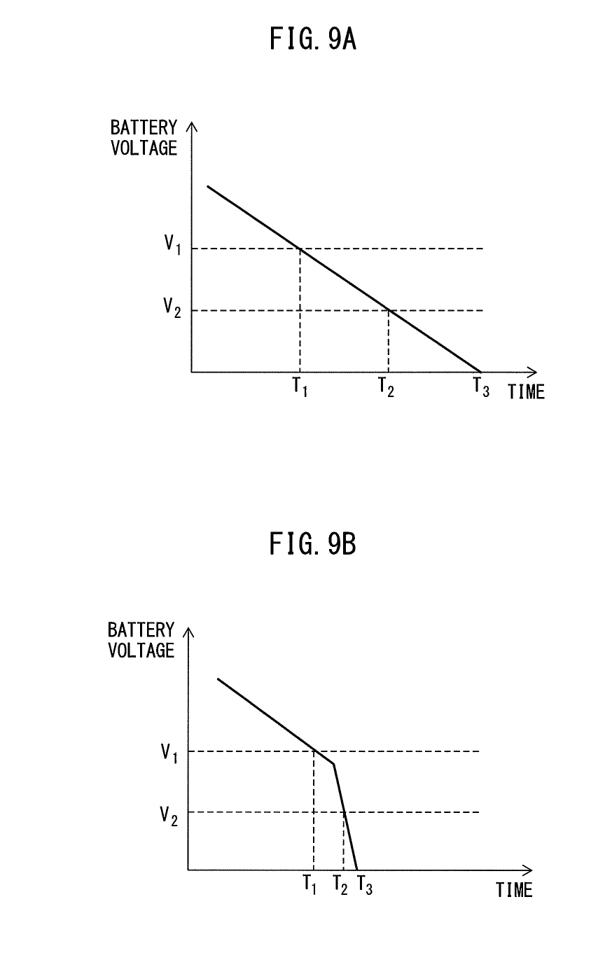

### DETAILED DESCRIPTION

A numerical control system which displays the voltage value of a backup battery will be described below with reference to the drawings. However, it is should be understood that the present invention is not limited to the drawings or embodiments described below.

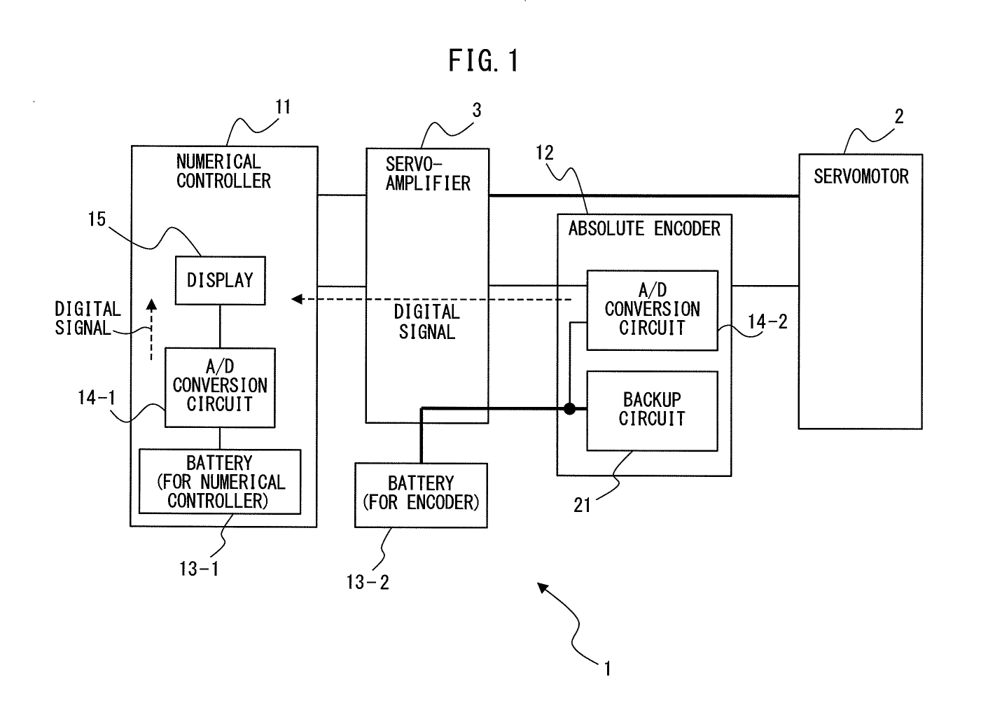

FIG. 1 is a block diagram illustrating the configuration of a numerical control system according to a first embodiment. Referring to FIG. 1, thin solid lines connecting the blocks together indicate signal lines, and thick solid lines indicate power lines.

According to the first embodiment, a numerical control system 1 includes a numerical controller 11, an absolute encoder 12, batteries 13-1 and 13-2, A/D conversion circuits 14-1 and 14-2, and a display 15.

The numerical controller 11 is connected to a servo-amplifier 3 for supplying drive power to a servomotor 2 equipped with a tool (not illustrated). The servomotor 2 is connected to the absolute encoder 12, which detects a rotational displacement of the servomotor 2. The rotational displacement of the servomotor 2 detected by the absolute encoder 12 is fed back to the numerical controller 11 and used for numerical control by the numerical controller 11. The numerical controller 11 controls the power output from the servo-amplifier 3 to allow desired numerical control, on the basis of the rotational displacement of the servomotor 2.

The battery 13-1 is located in the numerical controller 11 as a backup power supply at the time of power shutoff and supplies backup power to the numerical controller 11. The battery 13-2 is connected to the servo-amplifier 3 as a backup power supply for the absolute encoder 12 at the time of power shutoff and supplies backup power to a backup circuit 21 in the absolute encoder 12.

The A/D conversion circuit 14-1 is located in the numerical controller 11 supplied with backup power by the battery 13-1, and analog/digital-converts a voltage output from the battery 13-1 and outputs a digital signal. The digital signal output from the A/D conversion circuit 14-1 is sent to the display 15. The A/D conversion circuit 14-2 is located in the absolute encoder 12 supplied with backup power by the battery 13-2, and analog/digital-converts a voltage output from the battery 13-2 and outputs a digital signal. The digital signal output from the A/D conversion circuit 14-2 is sent to the display 15 in the numerical controller 11 via a signal line routed through the servo-amplifier 3.

The display 15 is located in the numerical controller 11, and displays the voltage value of the battery 13-1 on the basis of the digital signal output from the A/D conversion circuit 14-1 and displays the voltage value of the battery 13-2 on the basis of the digital signal output from the A/D conversion circuit 14-2.

Although both the battery 13-1 serving as a backup power supply for the numerical controller 11 and the battery 13-2 serving as a backup power supply for the absolute encoder 12 are provided in this embodiment, only one of these batteries may be provided. When the battery 13-1 or 13-2 that supplies backup power to either the numerical controller 11 or the absolute encoder 12 is provided, an A/D conversion circuit is located in one device selected from the numerical controller 11 and the absolute encoder 12 which one device is supplied with backup power by the battery. In other words, when the battery 13-1 is located in the numerical controller 11, the A/D conversion circuit 14-1 is located in the numerical controller 11. When the battery 13-2 that supplies backup power to the absolute encoder 12 is connected to the servo-amplifier 3, the A/D conversion circuit 14-2 is located in the absolute encoder 12. In any case, the display 15 displays the voltage value of the battery on the basis of a digital signal received from the A/D conversion circuit.

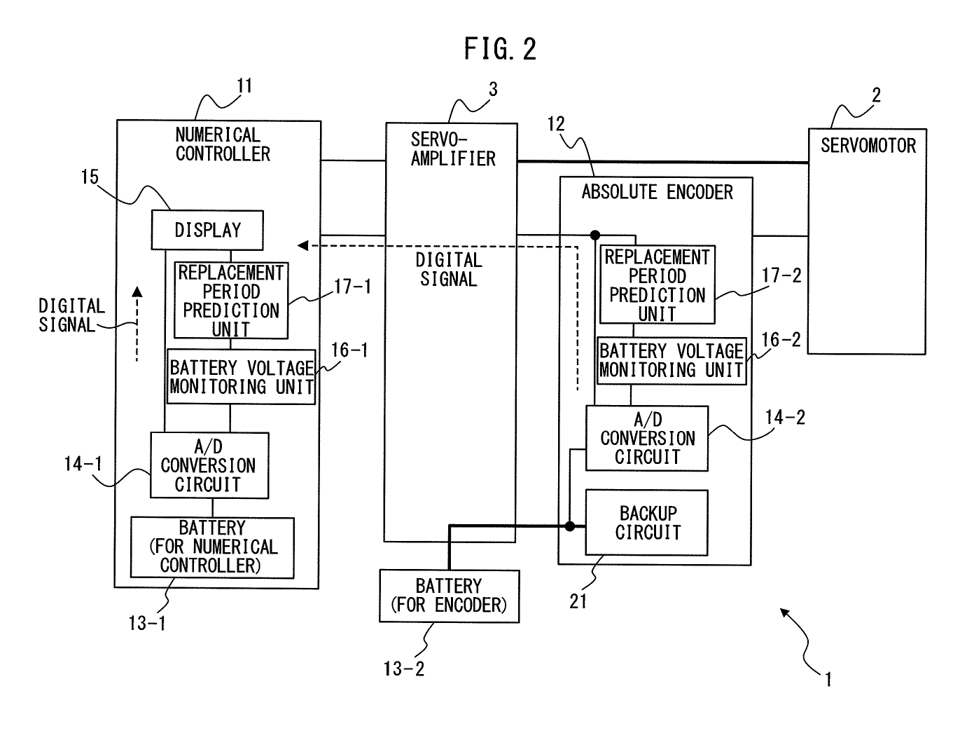

FIG. 2 is a block diagram illustrating the configuration of a numerical control system according to a second embodiment. Referring to FIG. 2, thin solid lines connecting the blocks together indicate signal lines, and thick solid lines indicate power lines.

The second embodiment is the numerical control system 1 according to the first embodiment described with reference to FIG. 1, which further includes battery voltage monitoring units 16-1 and 16-2 and replacement period prediction units 17-1 and 17-2. In other words, according to the second embodiment, the numerical control system 1 includes a numerical controller 11, an absolute encoder 12, batteries 13-1 and 13-2, A/D conversion circuits 14-1 and 14-2, a display 15, battery voltage monitoring units 16-1 and 16-2, and replacement period prediction units 17-1 and 17-2.

The battery voltage monitoring unit 16-1 is located in the numerical controller 11 and monitors the voltage drop tendency of the battery 13-1 on the basis of a digital signal output from the A/D conversion circuit 14-1. The battery voltage monitoring unit 16-2 is located in the absolute encoder 12 and monitors the voltage drop tendency of the battery 13-2 on the basis of a digital signal output from the A/D conversion circuit 14-2.

The replacement period prediction unit 17-1 is located in the numerical controller 11 and predicts the period to replace the battery 13-1 on the basis of the voltage drop tendency monitored by the battery voltage monitoring unit 16-1. The replacement period prediction unit 17-2 is located in the absolute encoder 12 and predicts the period to replace the battery 13-2 on the basis of the voltage drop tendency monitored by the battery voltage monitoring unit 16-2.

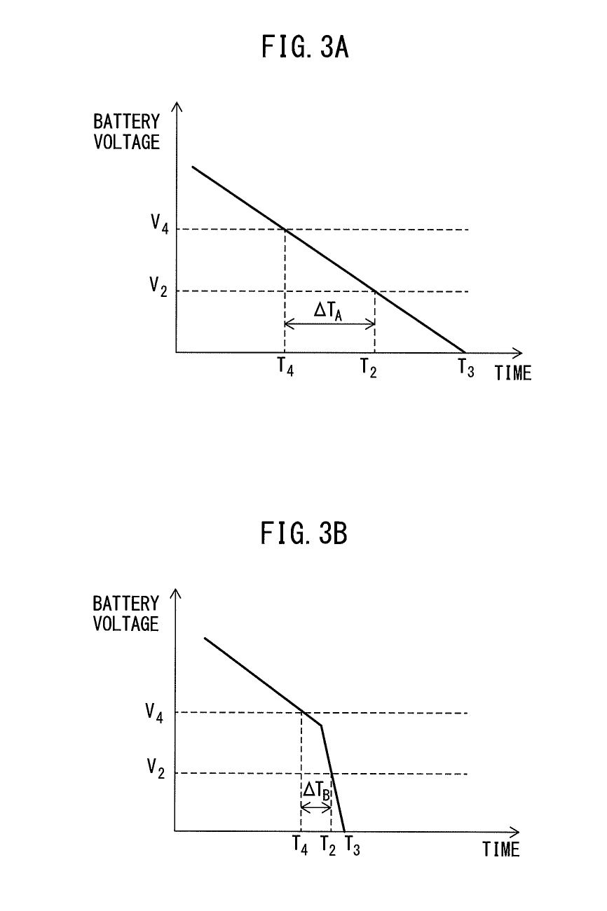

FIGS. 3A and 3B are graphs for explaining battery replacement period prediction in the second embodiment. The discharge characteristics vary depending on the type of battery, as depicted as FIGS. 3A and 3B, and thus the voltage drop tendency varies. Since the “voltage drop tendency of the battery” representing the ratio (gradient) of the drop in battery voltage over time is determined by the type of battery, a time instant T₂ at which the backup data will be lost can be predicted by computation, on the basis of the voltage drop tendency of each of the batteries 13-1 and 13-2 monitored by the battery voltage monitoring units 16-1 and 16-2, respectively. For example, in the voltage drop tendency of the battery as illustrated as FIG. 3A, each of the replacement period prediction units 17-1 and 17-2 first predicts and computes a time instant T₂ at which the backup data will be lost, on the basis of the ratio of the drop in battery voltage (e.g., its gradient assuming that the voltage drop tendency of the battery is represented by a linear decreasing function), and outputs a time instant T₄ (=T₂-ΔT_{A}) which is time of a predetermined time ΔT_{A} prior to the time instant T₂ as an “appropriate period to replace the battery.” As another example, in the voltage drop tendency of the battery as illustrated in FIG. 3B, each of the replacement period prediction units 17-1 and 17-2 first computes a time instant T₂ at which the backup data will be lost and outputs a time instant T₄ (=T₂-ΔT_{B}) which is tome of a predetermined time ΔT_{B} prior to the time instant T₂ as an “appropriate period to replace the battery.” These times ΔT_{A} and ΔT_{B} can be set as appropriate in accordance with, e.g., the time taken for the operator to perform an actual replacement operation and the activity schedule of the operator. Data associated with the periods to replace the batteries 13-1 and 13-2 output from the replacement period prediction units 17-1 and 17-2 are sent to the display 15 in the numerical controller 11 via a signal line routed through a servo-amplifier 3.

The display 15 displays the period to replace the battery 13-1 predicted by the replacement period prediction unit 17-1 and the period to replace the battery 13-2 predicted by the replacement period prediction unit 17-2. The display 15 may further display the voltage value of the battery 13-1 on the basis of a digital signal output from the A/D conversion circuit 14-1 and display the voltage value of the battery 13-2 on the basis of a digital signal output from the A/D conversion circuit 14-2, as in the first embodiment.

Although both the battery 13-1 serving as a backup power supply for the numerical controller 11 and the battery 13-2 serving as a backup power supply for the absolute encoder 12 are provided in this embodiment as well, only one of these batteries may be provided. When the battery 13-1 or 13-2 that supplies backup power to either the numerical controller 11 or the absolute encoder 12 is provided, a battery voltage monitoring unit and a replacement period prediction unit are located in one device selected from the numerical controller 11 and the absolute encoder 12 which one device is supplied with backup power by the battery. In other words, when the battery 13-1 is located in the numerical controller 11, the battery voltage monitoring unit 16-1 and the replacement period prediction unit 17-1 are located in the numerical controller 11. When the battery 13-2 that supplies backup power to the absolute encoder 12 is connected to the servo-amplifier 3, the battery voltage monitoring unit 16-2 and the replacement period prediction unit 17-2 are located in the absolute encoder 12. In any case, the display 15 displays the received period to replace the battery.

Since other components are the same as those illustrated in FIG. 1, the same reference signs denote the same components, and a detailed description thereof will not be given.

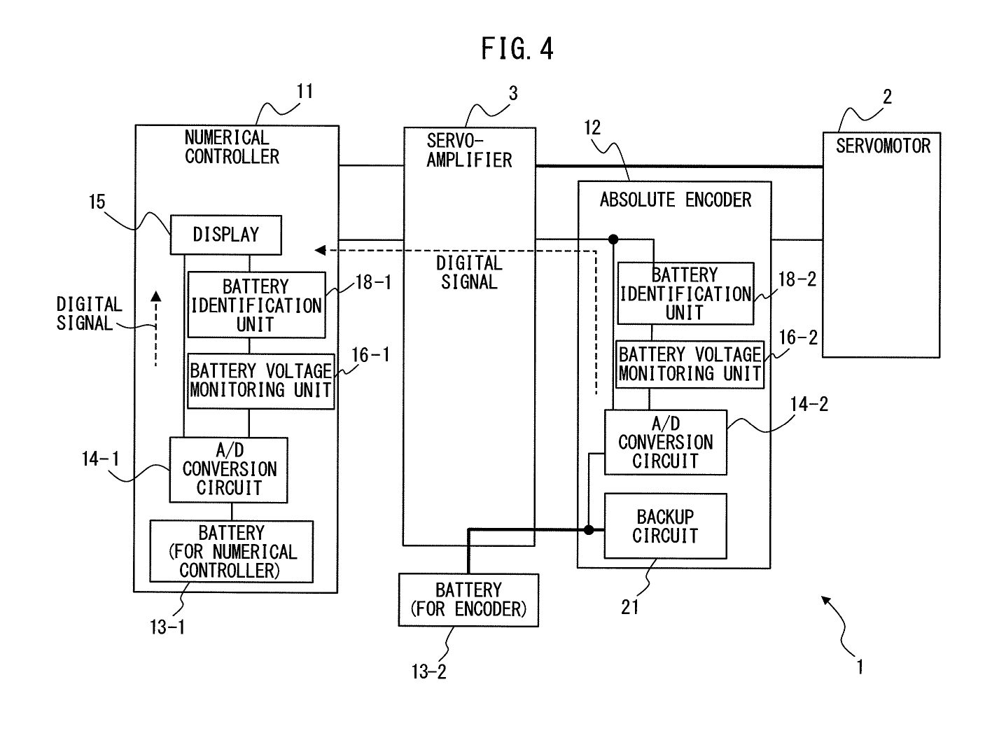

FIG. 4 is a block diagram illustrating the configuration of a numerical control system according to third and fourth embodiments. Referring to FIG. 4, thin solid lines connecting the blocks together indicate signal lines, and thick solid lines indicate power lines.

The third embodiment will be described first. The third embodiment is the numerical control system 1 according to the first embodiment described with reference to FIG. 1, which further includes battery voltage monitoring units 16-1 and 16-2 and battery identification units 18-1 and 18-2. In other words, according to the third embodiment, the numerical control system 1 includes a numerical controller 11, an absolute encoder 12, batteries 13-1 and 13-2, A/D conversion circuits 14-1 and 14-2, a display 15, battery voltage monitoring units 16-1 and 16-2, and battery identification units 18-1 and 18-2. Although the same components as in the third embodiment are provided in a fourth embodiment (to be described later), these embodiments provide different methods for identifying batteries using the battery identification units 18-1 and 18-2.

The battery voltage monitoring unit 16-1 is located in the numerical controller 11 and monitors the voltage drop tendency of the battery 13-1 on the basis of a digital signal output from the A/D conversion circuit 14-1. The battery voltage monitoring unit 16-2 is located in the absolute encoder 12 and monitors the voltage drop tendency of the battery 13-2 on the basis of a digital signal output from the A/D conversion circuit 14-2.

Further, in the third embodiment, the battery identification unit 18-1 is located in the numerical controller 11 and identifies the type of the battery 13-1 on the basis of the voltage drop tendency monitored by the battery voltage monitoring unit 16-1. The battery identification unit 18-2 is located in the absolute encoder 12 and identifies the type of the battery 13-2 on the basis of the voltage drop tendency monitored by the battery voltage monitoring unit 16-2. The “type of battery” means herein information for specifying a battery, including, e.g., the name, model number, manufacturer, date of manufacture, and lot number of the battery.

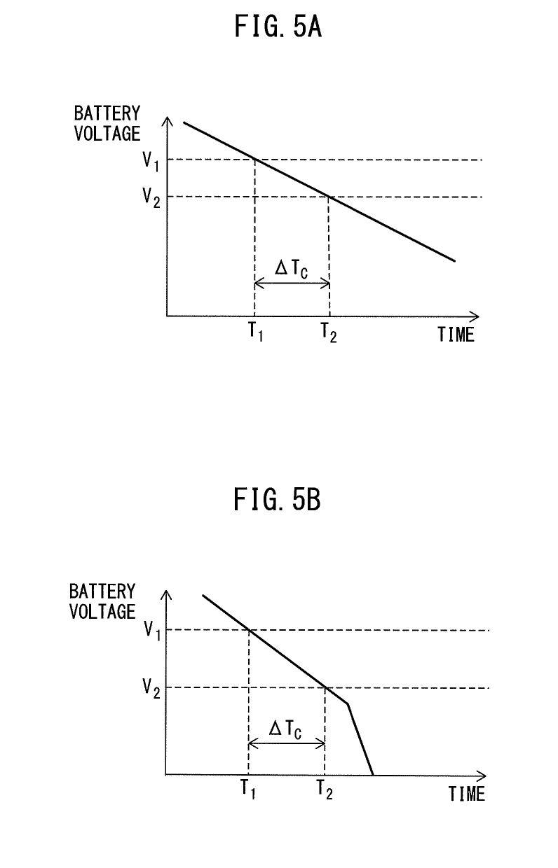

FIGS. 5A and 5B are graphs for explaining battery type identification in the third embodiment. The discharge characteristics vary depending on the type of battery, as depicted in FIGS. 5A and 5B and thus the voltage drop tendency also varies. Since the “voltage drop tendency of the battery” representing the ratio (gradient) of the drop in battery voltage over time is determined by the type of battery, the type of battery can be identified on the basis of the digital signals used to monitor the voltage drop tendency of each of the batteries 13-1 and 13-2 by the battery voltage monitoring units 16-1 and 16-2, respectively, during a predetermined time ΔT_{c}. Since, for example, the battery voltage drop tendency as illustrated in FIG. 5A is different from that as illustrated in FIG. 5B, the battery identification units 18-1 and 18-2 identify the types of batteries from the voltage drop tendencies during the predetermined time ΔT_{c}. The discharge characteristics of batteries are generally stipulated in their specification tables or the like and are input to the battery identification units 18-1 and 18-2 as reference data in advance so that the battery identification units 18-1 and 18-2 perform processing for identifying the batteries on the basis of the reference data. Data associated with the types of the batteries 13-1 and 13-2 output from the battery identification units 18-1 and 18-2 are sent to the display 15 in the numerical controller 11 via a signal line routed through a servo-amplifier 3.

The display 15 displays the type of the battery 13-1 identified by the battery identification unit 18-1 and the type of the battery 13-2 identified by the battery identification unit 18-2. Since the operator can confirm the type of the battery 13-2 from the information displayed on the display 15, the operation burden is reduced without need to visually confirm an actual battery during, e.g., maintenance. The display 15 may display the voltage value of the battery 13-1 on the basis of a digital signal output from the A/D conversion circuit 14-1 and display the voltage value of the battery 13-2 on the basis of a digital signal output from the A/D conversion circuit 14-2, as in the first embodiment.

Although both the battery 13-1 serving as a backup power supply for the numerical controller 11 and the battery 13-2 serving as a backup power supply for the absolute encoder 12 are provided in this embodiment as well, only either of these batteries may be provided. When the battery 13-1 or 13-2 that supplies backup power to either the numerical controller 11 or the absolute encoder 12 is provided, a battery voltage monitoring unit and a battery identification unit are located in one device selected from the numerical controller 11 and the absolute encoder 12 which one device is supplied with backup power by the battery. In other words, when the battery 13-1 is located in the numerical controller 11, the battery voltage monitoring unit 16-1 and the battery identification unit 18-1 are located in the numerical controller 11. When the battery 13-2 that supplies backup power to the absolute encoder 12 is connected to the servo-amplifier 3, the battery voltage monitoring unit 16-2 and the battery identification unit 18-2 are located in the absolute encoder 12. In any case, the display 15 displays the received type of the battery.

Since other components are the same as those illustrated as FIG. 1, the same reference sign denote the same components, and a detailed description thereof will not be given.

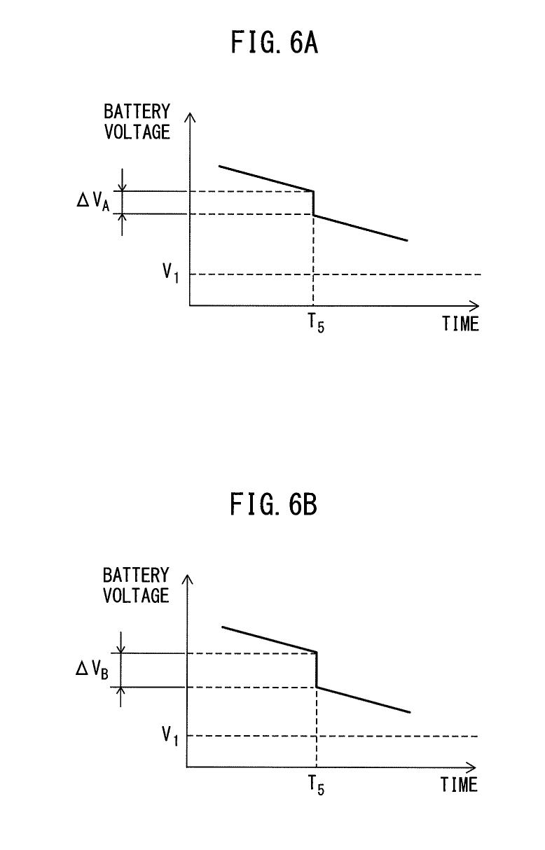

FIGS. 6A and 6B are graphs for explaining battery type identification in the fourth embodiment. The fourth embodiment is a modification of the method for identifying the types of batteries using the battery identification units 18-1 and 18-2 in the above-described third embodiment. Features other than the method for identification using the battery identification units 18-1 and 18-2 are the same as in the third embodiment described with reference to FIG. 4.

According to the fourth embodiment, the battery identification unit 18-1 identifies the type of a battery 13-1 using, as the voltage drop tendency monitored by a battery voltage monitoring unit 16-1, the amount of voltage variation of the battery 13-1 during the period in which the power of the battery 13-1 consumed by a numerical controller 11 is higher than a predetermined value. The battery identification unit 18-2 identifies the type of a battery 13-2 using, as the voltage drop tendency monitored by a battery voltage monitoring unit 16-2, the amount of voltage variation of the battery 13-2 during the period in which the power of the battery 13-2 consumed by an absolute encoder 12 is higher than a predetermined value. The value of the battery internal resistance generally varies depending on the type of battery. In the state in which the battery voltage is higher than a voltage V₁ at which a battery voltage drop alarm occurs, the amount of voltage variation during the period in which the battery power consumption is higher than a predetermined value depends on the battery internal resistance, as depicted in FIGS. 6A and 6B. When, for example, the batteries as illustrated in FIGS. 6A and 6B have different internal resistances, the amounts of variation in voltage ΔV_{A} and ΔV_{B} during the period in which the power consumption is higher than a predetermined value for each battery are different from each other. The battery identification units 18-1 and 18-2 therefore identify the types of batteries using, as the voltage drop tendencies monitored by the battery voltage monitoring units 16-1 and 16-2, the amounts of voltage variation of the batteries during the period in which the power consumptions of the batteries are higher than a predetermined value. Note that data associated with the amounts of voltage variation of batteries during the period in which the power consumptions of the batteries are higher than a predetermined value are obtained by experiment in advance and input to the battery identification units 18-1 and 18-2 as reference data in advance so that the battery identification units 18-1 and 18-2 perform processing for identifying the batteries on the basis of the reference data. Data associated with the types of the batteries 13-1 and 13-2 and output from the battery identification units 18-1 and 18-2 are sent to a display 15 in the numerical controller 11 via a signal line routed through a servo-amplifier 3.

The display 15 displays the type of the battery 13-1 identified by the battery identification unit 18-1 and the type of the battery 13-2 identified by the battery identification unit 18-2. The display 15 may further display the voltage value of the battery 13-1 on the basis of a digital signal output from the A/D conversion circuit 14-1 and display the voltage value of the battery 13-2 on the basis of a digital signal output from the A/D conversion circuit 14-2, as in the first embodiment.

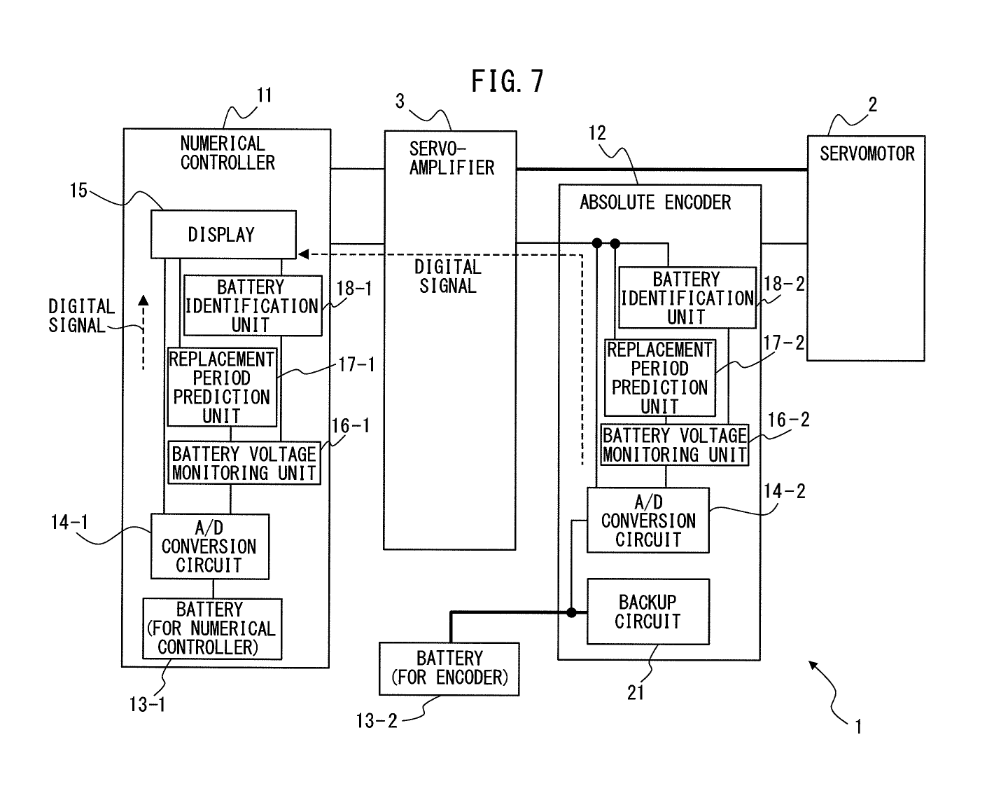

FIG. 7 is a block diagram illustrating the configuration of a numerical control system according to a fifth embodiment. Referring to FIG. 7, thin solid lines connecting the blocks together indicate signal lines, and thick solid lines indicate power lines.

The fifth embodiment is a combination of the second embodiment and the third or fourth embodiment. In other words, according to the fifth embodiment, a numerical control system 1 includes a numerical controller 11, an absolute encoder 12, batteries 13-1 and 13-2, A/D conversion circuits 14-1 and 14-2, a display 15, battery voltage monitoring units 16-1 and 16-2, replacement period prediction units 17-1 and 17-2, and battery identification units 18-1 and 18-2.

The battery voltage monitoring unit 16-1 is located in the numerical controller 11 and monitors the voltage drop tendency of the battery 13-1 on the basis of a digital signal output from the A/D conversion circuit 14-1. The battery voltage monitoring unit 16-2 is located in the absolute encoder 12 and monitors the voltage drop tendency of the battery 13-2 on the basis of a digital signal output from the A/D conversion circuit 14-2.

The battery identification unit 18-1 is located in the numerical controller 11 and identifies the type of the battery 13-1, and the battery identification unit 18-2 is located in the absolute encoder 12 and identifies the type of the battery 13-2. Either method described in the third or fourth embodiment is applicable to identify the batteries 13-1 and 13-2 using the battery identification units 18-1 and 18-2.

The display 15 displays the period to replace the battery 13-1 predicted by the replacement period prediction unit 17-1, the period to replace the battery 13-2 predicted by the replacement period prediction unit 17-2, the type of the battery 13-1 identified by the battery identification unit 18-1, and the type of the battery 13-2 identified by the battery identification unit 18-2. The display 15 may further display the voltage value of the battery 13-1 on the basis of a digital signal output from the A/D conversion circuit 14-1 and display the voltage value of the battery 13-2 on the basis of a digital signal output from the A/D conversion circuit 14-2, as in the first embodiment.

Since other components are the same as those illustrated in FIGS. 2 and 4, the same reference signs denote the same components, and a detailed description thereof will not be given.

The above-described battery voltage monitoring units 16-1 and 16-2, replacement period prediction units 17-1 and 17-2, and battery identification units 18-1 and 18-2 may be constructed in, e.g., the software program form or by a combination of various digital electronic circuits and software programs. When, for example, these units are constructed in the software program form, the above-mentioned functions of the respective units are implemented by installing the software programs on arithmetic processors in the numerical controller 11 and the absolute encoder 12 and then by operating the above-mentioned respective units in accordance with the software programs. When, for example, these units are constructed by a combination of various digital electronic circuits and software programs, the above-mentioned functions of the respective units are implemented by building digital electronic circuits into the arithmetic processor in the numerical controller 11 and the absolute encoder 12 or using already mounted digital electronic circuits, installing the software programs on the arithmetic processors in the numerical controller 11 and the absolute encoder 12, operating the above-mentioned respective units in accordance with the software programs, and operating the digital electronic circuits. In this manner, according to the present invention it is not needed to involve any separate devices which result in increasing the cost.

According to the present invention, a low-cost numerical control system which can easily predict an appropriate period to replace a backup battery can be achieved. According to the present invention, since the operator can know an appropriate timing to replace a battery on the basis of a drop in battery voltage for supplying backup power to a numerical controller and an absolute encoder in the numerical control system, loss of backup data can be prevented.

According to the present invention, the operator can easily confirm the type of battery which supplies backup power to the numerical controller and the absolute encoder in the numerical control system. This may not involve visual confirmation of an actual battery during, e.g., maintenance, thus reducing the operation burden on the operator.

The present invention may even involve no separate devices which increase the cost.

What is claimed is:

1. A numerical control system comprising:
a numerical controller;
an absolute encoder which detects a rotational displacement of a motor controlled by the numerical controller;
a battery which supplies backup power to at least one device selected from the numerical controller and the absolute encoder;
an A/D conversion circuit which analog/digital-converts a voltage output from the battery and outputs a digital signal, the A/D conversion circuit being located in the one device selected from the numerical controller and the absolute encoder which one device is supplied with a backup voltage by the battery; and
a display which displays a voltage value of the battery on the basis of the digital signal and is located in the numerical controller.

2. The numerical control system according to claim 1, further comprising:
a battery voltage monitoring unit which monitors a voltage drop tendency of the battery on the basis of the digital signal; and
a replacement period prediction unit which predicts a period to replace the battery on the basis of the voltage drop tendency,
wherein the display displays the period to replace the battery predicted by the replacement period prediction unit.

3. The numerical control system according to claim 2, wherein the battery voltage monitoring unit and the replacement period prediction unit are located in the one device selected from the numerical controller and the absolute encoder which is supplied with a backup power by the battery.

4. The numerical control system according to claim 1, further comprising:
a battery voltage monitoring unit which monitors a voltage drop tendency of the battery on the basis of the digital signal; and
a battery identification unit which identifies a type of the battery on the basis of the voltage drop tendency,
wherein the display displays the type of the battery identified by the battery identification unit.

5. The numerical control system according to claim 4, wherein the battery identification unit identifies a type of the battery using, as the voltage drop tendency, an amount of voltage variation of the battery during a period in which a power of the battery consumed by the numerical controller or the absolute encoder is higher than a predetermined value.

6. The numerical control system according to claim 4, wherein the battery voltage monitoring unit and the battery identification unit are located in the one device selected from the numerical controller and the absolute encoder which one device is supplied with a backup power by the battery.
